(19) United States
(12) Patent Application Publication
(10) Pub. No.: US 2011/0077793 A1
(43) Pub. Date: Mar. 31, 2011

(54) LONG-DISTANCE POE SYSTEM, POWER SOURCING EQUIPMENT AND POWER SOURCING METHOD

(75) Inventors: SHUI-LAI HSIEH, TAOYUAN COUNTY 330 (TW); HSIANG-KAI LIAO, TAICHUNG CITY 404 (TW)

(73) Assignee: PIXORD CORPORATION, TAOYUAN COUNTY 330 (TW)

(21) Appl. No.: 12/890,902

(22) Filed: Sep. 27, 2010

(30) Foreign Application Priority Data
Sep. 29, 2009 (TW) 098132931

(51) Int. Cl. G06F 1/26

(52) U.S. Cl. 700/297

(57) ABSTRACT

A long-distance PoE power sourcing equipment includes a PoE local power supply, a PoE remote switch, and a link cable linked therebetween. The PoE local power supply serves as a conversion medium between a network signal and a first transmission signal and sources a first DC power to the PoE remote switch through the link cable. The PoE remote switch serves as a conversion medium between the first transmission signal and a second transmission signal and converts the first DC power into a second DC power supplied to a PoE power device through an Ethernet cable. The power transmission implemented by the PoE local power supply and the link cable allows the data and power transmission distance of the PoE system to exceed the distance limitation of the Ethernet specification.

### FIELD OF THE INVENTION

The present invention is related generally to a Power over Ethernet (PoE) system and, more particularly, to long-distance PoE power sourcing equipment and method.

### BACKGROUND OF THE INVENTION

Power over Ethernet (PoE) refers to a technology for power transmission over an Ethernet cable, by which electric power can be directly supplied to an Ethernet equipment, for example, Voice-over-IP (VoIP) phone, wireless access point, IP camera, hub, and the like, through an Ethernet cable without using an additional power cord or modifying the structure of the Ethernet cable. In addition to PoE, there have been many other terms referring to the technology for power transmission over an Ethernet cable, for example, Power over LAN (PoL Power on LAN (PoL), and Inline Power, etc. IEEE 802.3-2005 (usually referred to as IEEE 802.3af) is a PoE standard approved by IEEE that is established based on a Category 5 cable (Cat-5), typically referred to as Ethernet cable, with its first, second, third and sixth pairs of twisted wires for data transmission, and its fourth, fifth, seventh and eighth pairs of twisted wires for power transmission. The current PoE technology can only provide direct-current (DC) power sourcing of maximum voltage 48V, maximum current 400 mA, and maximum power 14.4 W. As a PoE power sourcing switch wastes approximately 10%-20% of the supplied power, only about 12.95 W of power is available for use by the PoE network equipments linked to the PoE switch, considering the transmission loss.

In further detail, as shown in FIG. 1, a PoE system 10 includes a PoE switch 14 as the PoE power sourcing equipment (PSE) and one or more PoE power devices (PDs) 18, for example, IP camera with PoE function. The Power and data transmission between the PoE switch 14 and the PoE power device 18 is accomplished by an Ethernet cable 16, and the data transmission between a control console 12, for example, computer or NB, and the PoE power device 18 must be assisted by the PoE switch 14 therebetween.

Since the current PoE technology can only provide available power of less than 13 W for the PoE power devices 18, it is impossible to support any network equipment having demanded power of more than 13 W, for example, IP camera with pan-tilt-zoom (PTZ) function or spherical type IP camera. The update IEEE 802.3 at standard for PoE, which was approved in 2009, enables its power sourcing specification to be higher, up to 30 W, and thereby reduces the barrier caused by insufficient PoE power sourcing capability; however, the limitation on PoE power transmission distance remains. Referring to FIG. 1, due to the limitation of Ethernet, the distance between the PoE switch 14 and the PoE power devices 18 is limited to less than 100 m. If a distance over 100 m is desired, it requires several cascade PoE switches to relay the power and network signals being transmitted. However, as the supplied power attenuates over the transmission distance, the extension of distance actually achieved is still very limited. Moreover, the large number of nodes formed in the cascade architecture makes subsequent maintenance very inconvenient and requires considerable manpower and time for inspection.

Therefore, it is desired a long-distance PoE power sourcing equipment and method to overcome the above drawbacks.

### SUMMARY OF THE INVENTION

An object of the present invention is to provide a long-distance PoE power sourcing equipment.

Another object of the present invention is to provide a long-distance PoE power sourcing method.

A further object of the present invention is to provide a long-distance PoE system.

According to the present invention, a long-distance PoE system includes a PoE local power supply to receives an AC or DC power source and communicates with a control console outside the PoE system by a network signal, a PoE remote switch, a link cable linked between the PoE local power supply and the PoE remote switch for communication between the PoE local power supply and the PoE remote switch by a first transmission signal, a PoE power device, and an Ethernet cable linked between the PoE remote switch and the PoE power device for communication between the PoE remote switch and the PoE power device by a second transmission signal. The PoE local power supply sources a first DC power to the PoE remote switch through the link cable, the PoE remote switch converts the first DC power into a second DC power supplied to the PoE power device through the same Ethernet cable, and the first DC power has a higher voltage than the second DC power.

According to the present invention, a long-distance PoE power sourcing equipment includes a PoE local power supply to serve as a conversion medium between a network signal and a first transmission signal and to provide a first DC power, a link cable connected to the PoE local power supply to provide a transmission path for the first transmission signal and the first DC power, and a PoE remote switch connected to the link cable to serve as a conversion medium between the first transmission signal and a second transmission signal and to convert the first DC power into a second DC power having a voltage lower than that of the first DC power.

According to the present invention, a long-distance PoE power sourcing method includes generating a first DC power, transmitting a first transmission signal and the first DC power to a remote end, converting the first transmission signal into a second transmission signal and converting the first DC power into a second DC power at the remote end, and transmitting the second transmission signal and the second DC power to a PoE power device. The first DC power has a higher voltage than the second DC power.

### BRIEF DESCRIPTION OF THE DRAWINGS

These and other objects, features and advantages of the present invention will become apparent to those skilled in the art upon consideration of the following description of the preferred embodiments of the present invention taken in conjunction with the accompanying drawings, in which:

FIG. 1 is a block diagram of a conventional PoE system;

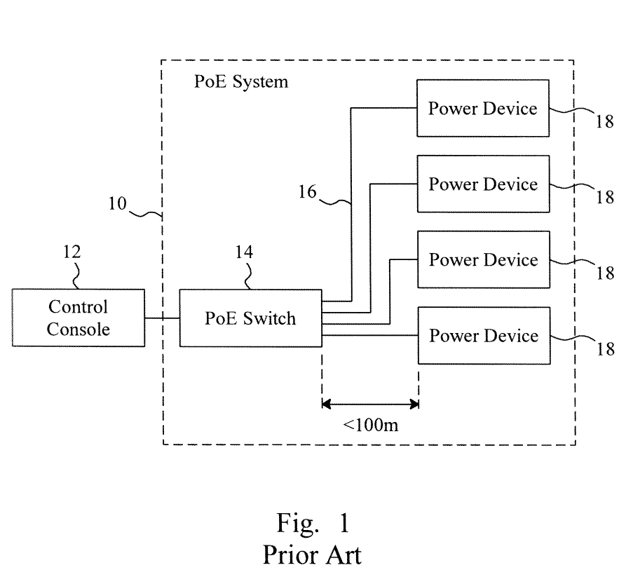

FIG. 2 a block diagram showing a long-distance PoE architecture according to the present invention;

FIG. 3 a block diagram of a PoE local power supply according to the present invention; and

FIG. 4 a block diagram of a PoE remote switch according to the present invention.

### DETAILED DESCRIPTION OF THE INVENTION

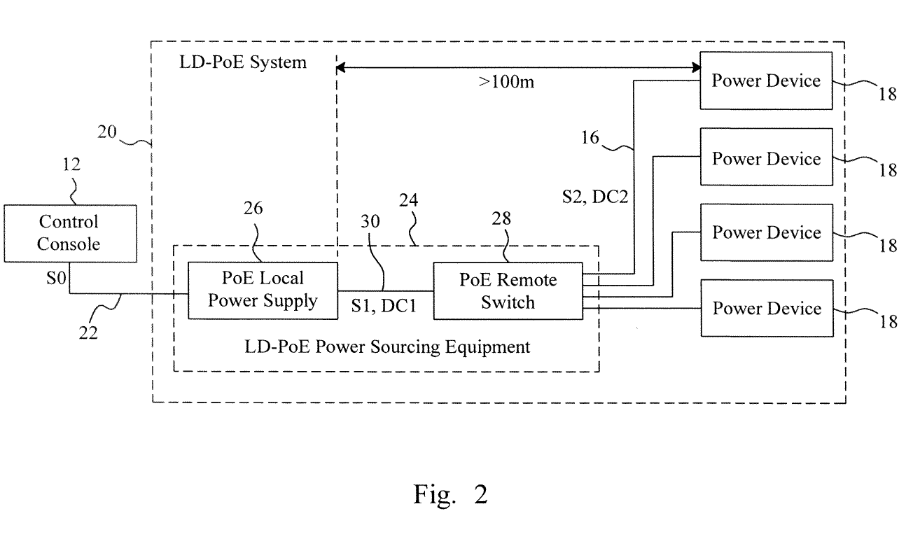

As shown in FIG. 2, in a long-distance PoE system 20 according to the present invention, a PoE local power supply 26, a PoE remote switch 28, and a link cable 30 linked therebetween establish a long-distance PoE power sourcing equipment 24, and each PoE power device 18 is linked to the PoE remote switch 28 by a Ethernet cable 16. The link cable 30 may be a twisted-pair line, a telephone line, an Ethernet cable, or a coaxial cable. A control console 12 for the PoE system 20 is linked to the PoE local power supply 26 by an Ethernet cable 22 or via a network environment, and the communication between the control console 12 and the PoE local power supply 26 is accomplished by a network signal S0 over the Ethernet cable 22 or a network environment. Between the PoE local power supply 26 and the PoE remote switch 28 is transmitted a first transmission signal S1 over the link cable 30, and between the PoE remote switch 28 and the PoE power device 18 is transmitted a second transmission signal S2 over the Ethernet cable 16. The PoE local power supply 26 serves as a conversion medium between the network signal S0 and the first transmission signal S1, to convert the network signal S0 into the first transmission signal S1 or to convert the first transmission signal S1 into the network signal S0. The PoE remote switch 28 serves as a conversion medium between the first transmission signal S1 and the second transmission signal S2, to convert the first transmission signal S1 into the second transmission signal S2 or to convert the second transmission signal S2 into the first transmission signal S1. The PoE local power supply 26 also sources a first DC power DC1 to the PoE remote switch 28 over the link cable 30, and the PoE remote switch 28 converts the first DC power DC1 into a second DC power DC2 according to the PoE specification. The second DC power DC2 is supplied to the PoE power device 18 over the Ethernet cable 16. The first DC power DC1 has a higher voltage than that of the second DC power DC2. Although the Ethernet cable 16 is still shorter than 100 m due to the distance limitation of the Ethernet specification, the power transmission implemented by the PoE local power supply 26 and the link cable 30 allows the power transmission distance of the PoE local power supply 26 to extend beyond 100 m without need of any other cascade PoE switch. In an embodiment, a Cat-5 cable is used as the Ethernet cable 16, in which the first, second, third and sixth pairs of twisted wires are used for transmitting the second transmission signal S2, and the fourth, fifth, seventh and eighth pairs of twisted wires are used for transmitting the second DC power DC2. Hence, the PoE power device 18 can operate normally as long as it is connected to the Ethernet cable 16.

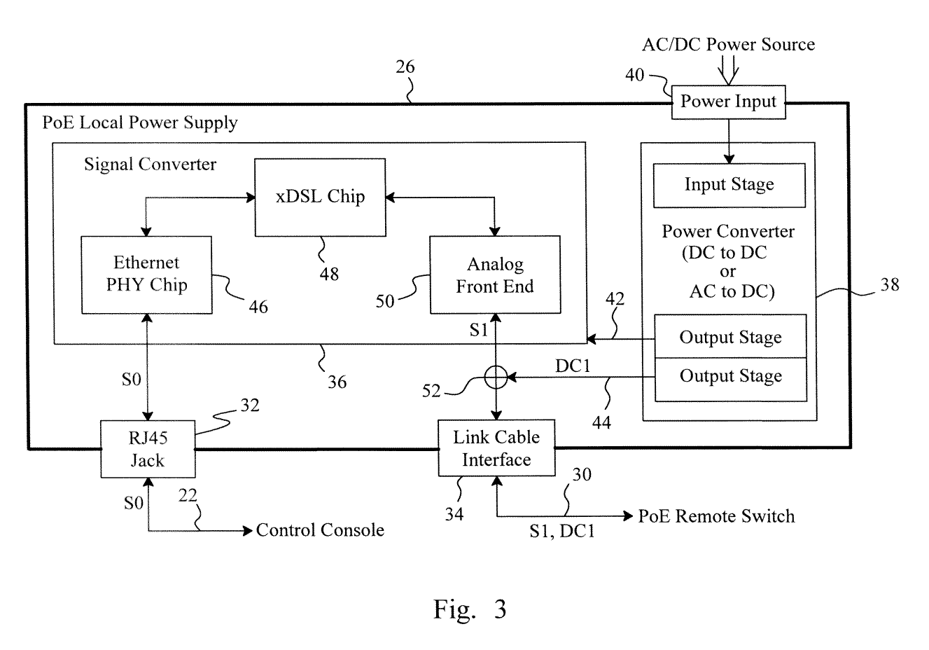

FIG. 3 shows an embodiment for the PoE local power supply 26, which includes a RJ45 jack 32 to communicate with the control console 12 over the Ethernet cable 22 or connect with a network environment, a link cable interface 34 to connect to the PoE remote switch 28 through the link cable 30, a signal converter 36 connected to the RJ45 jack 32 to convert the network signal S0 into the first transmission signal S1 or vice versa, a power input 40 to be connected with an AC or DC power source, for example a commercial power source of ±90˜240V, a power converter module 38 connected to the power input 40 to convert the AC or DC source power to an internal DC power 42 supplied to the signal converter 36 and a first DC power 44 to be combined with the first transmission signal S1 at a joint 52 to be transmitted from the link cable interface 34 to the PoE remote switch 28. The first transmission signal S1 from the PoE remote switch 28 is fed into the signal converter 36 via the link cable interface 34 and the joint 52. The signal converter 36 includes an Ethernet PHY chip 46 connected to the RJ45 jack 32, an xDSL chip 48 connected to the Ethernet PHY chip 46, and an analog front end 50 connected the xDSL chip 48 and the joint 52. The network signal S0 from the control console 12 is received by the Ethernet PHY chip 46 from the RJ45 jack 32 and modulated by the xDSL chip 48 into an xDSL signal, which is then sent from the analog front end 50 to the joint 52 as the first transmission signal S1 to be transmitted to the PoE remote switch 28. Conversely, the first transmission signal S1 from the PoE remote switch 28 is received by the analog front end 50 via the joint 52, demodulated by the xDSL chip 48, and then sent from the Ethernet PHY chip 46 to the RJ45 jack 32.

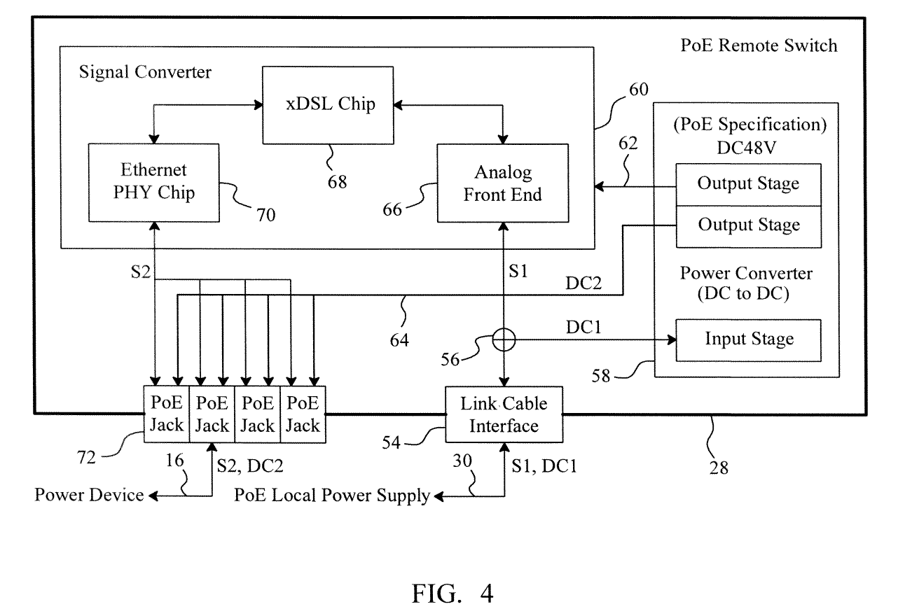

FIG. 4 shows an embodiment for the PoE remote switch 28, in which a link cable interface 54 is to connect to the PoE local power supply 26 through the link cable 30, the first DC power DC1 received from the PoE local power supply 26 is provided to a power converter 58 via a joint 56, where the first DC power DC1 is converted into an internal DC power 62 supplied to a signal converter 60 and a second DC power 64 supplied to a set of PoE jacks 72, and the first transmission signal S1 received from the PoE local power supply 26 is fed via the joint 56 into the signal converter 60 to be converted into the second transmission signal S2 to transmit to the PoE jacks 72. The signal converter 60 includes an analog front end 66 connected to the joint 56, an xDSL chip 68 connected to the analog front end 66, and an Ethernet PHY chip 70 connected to the xDSL chip 68 and the PoE jacks 72. The first transmission signal S1 from the PoE local power supply 26 is received by the analog front end 66 via the junction 56, demodulated by the xDSL chip 68, and then sent from the Ethernet PHY chip 70 to the PoE jacks 72 as the second transmission signal S2. Conversely, the second transmission signal S2 from the power device 18 is received by the Ethernet PHY chip 70 via the PoE jacks 72, modulated by the xDSL chip 68 into an xDSL signal, and then sent from the analog front end 66 to the joint 56 as the first transmission signal S1 to be transmitted to the PoE local power supply 26. In this embodiment, the second DC power DC2 is converted from the first DC power DC1 according to the PoE specification, and the second transmission signal S2 also conforms to the PoE specification.

As shown in FIGS. 3 and 4, the first transmission signal S1 between the PoE local power supply 26 and the PoE remote switch 28 is an xDSL modulated signal, whose transmission distance follows the xDSL specification. Taking VDSL for example, the transmission distance can be as long as several hundred meters, which is longer than the 100 m limitation of the Ethernet specification.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A long-distance PoE system comprising:
a PoE local power supply receiving an AC or DC power source and communicating with a control console outside the PoE system by a network signal;
a PoE remote switch;
a link cable linked between the PoE local power supply and the PoE remote switch, for communication between the PoE local power supply and the PoE remote switch by a first transmission signal;
a PoE power device; and
an Ethernet cable linked between the PoE remote switch and the PoE power device, for communication between the PoE remote switch and the PoE power device by a second transmission signal;
wherein the PoE local power supply sources a first DC power to the PoE remote switch through the link cable, the PoE remote switch converts the first DC power into a second DC power supplied to the PoE power device through the Ethernet cable, and the first DC power has a higher voltage than the second DC power.

2. The PoE system of claim 1, wherein the PoE local power supply comprises:
a power converter operative to convert the AC or DC power source into the first DC power;
a signal converter operative to convert the network signal into the first transmission signal or convert the first transmission signal into the network signal; and
a joint connected to the power converter and the signal converter, operative to receive the first DC power from the power converter, transmit the first transmission signal to the signal converter, and receive the first transmission signal from the signal converter.

3. The PoE system of claim 2, wherein the power converter generates an internal DC power supplied to the signal converter.

4. The PoE system of claim 2, wherein the signal converter comprises:
an Ethernet PHY chip operative to receive and transmit the network signal;
an analog front end operative to receive and transmit the first transmission signal; and
an xDSL chip connected between the Ethernet PHY chip and the analog front end, operative to modulate the network signal or demodulate the first transmission signal.

5. The PoE system of claim 1, wherein the PoE remote switch comprises:
a power converter operative to convert the first DC power into the second DC power;
a signal converter operative to convert the first transmission signal into the second transmission signal or convert the second transmission signal into the first transmission signal; and
a joint connected to the power converter and the signal converter, operative to provide the first DC power to the power converter, transmit the first transmission signal to the signal converter, and receive the first transmission signal from the signal converter.

6. The PoE system of claim 5, wherein the power converter generates an internal DC power supplied to the signal converter.

7. The PoE system of claim 5, wherein the signal converter comprises:
an Ethernet PHY chip operative to receive and transmit the second transmission signal;
an analog front end operative to receive and transmit the first transmission signal; and
an xDSL chip connected between the Ethernet PHY chip and the analog front end, operative to demodulate the first transmission signal or modulate the second transmission signal.

8. The PoE system of claim 1, wherein the link cable is a wisted-pair line, a telephone line, an Ethernet cable, or a coaxial cable.

9. A long-distance PoE power sourcing equipment comprising:
a PoE local power supply operative to serve as a conversion medium between a network signal and a first transmission signal and to provide a first DC power;
a link cable connected to the PoE local power supply, providing a transmission path for the first transmission signal and the first DC power; and
a PoE remote switch connected to the link cable, operative to serve as a conversion medium between the first transmission signal and a second transmission signal and to convert the first DC power into a second DC power having a voltage lower than that of the first DC power.

10. The PoE power sourcing equipment of claim 9, wherein the PoE local power supply comprises:
a power converter operative to generate the first DC power;
a signal converter connected to the power converter, operative to convert the network signal into the first transmission signal or convert the first transmission signal into the network signal; and
a joint connected to the power converter and the signal converter, operative to receive the first DC power from the power converter, transmit the first transmission signal to the signal converter, and receive the first transmission signal from the signal converter.

11. The PoE power sourcing equipment of claim 10, wherein the power converter generates an internal DC power supplied to the signal converter.

12. The PoE power sourcing equipment of claim 10, wherein the signal converter comprises:
an Ethernet PHY chip operative to receive and transmit the network signal;
an analog front end operative to receive and transmit the first transmission signal; and
an xDSL chip connected between the Ethernet PHY chip and the analog front end, operative to modulate the network signal or demodulate the first transmission signal.

13. The PoE power sourcing equipment of claim 9, wherein the PoE remote switch comprises:
a power converter operative to convert the first DC power into the second DC power;
a signal converter connected to the power converter, operative to convert the first transmission signal into the second transmission signal or convert the second transmission signal into the first transmission signal; and
a joint connected to the power converter and the signal converter, operative to provide the first DC power to the power converter, transmit the first transmission signal to the signal converter, and receive the first transmission signal from the signal converter.

14. The PoE power sourcing equipment of claim 13, wherein the power converter generates an internal DC power supplied to the signal converter.

15. The PoE power sourcing equipment of claim 13, wherein the signal converter comprises:
an Ethernet PHY chip operative to receive and transmit the second transmission signal;
an analog front end operative to receive and transmit the first transmission signal; and
an xDSL chip connected between the Ethernet PHY chip and the analog front end, operative to demodulate the first transmission signal or modulate the second transmission signal.

16. The PoE power sourcing equipment of claim 9, wherein the link cable is a twisted-pair line, a telephone line, an Ethernet cable, or a coaxial cable.

17. A long-distance PoE power sourcing method comprising the steps of:
generating a first DC power;
transmitting a first transmission signal and the first DC power to a remote end;
converting the first transmission signal into a second transmission signal and converting the first DC power into a second DC power at the remote end, wherein the first DC power has a higher voltage than the second DC power; and
transmitting the second transmission signal and the second DC power to a PoE power device.

18. The PoE power sourcing method of claim 17, further comprising the step of modulating a network signal into the first transmission signal.

19. The PoE power sourcing method of claim 17, further comprising the step of demodulating the first transmission signal into the second transmission signal.
